(19) United States
(12) Patent Application Publication
(10) Pub. No.: US 2026/0253253 A1
(43) Pub. Date: Aug. 27, 2026

(54) METHOD FOR ESTIMATING A HEIGHT AT WHICH A CAMERA MODULE IS INSTALLED IN A VEHICLE, AND METHOD FOR UPDATING AN ALGORITHM OF A DRIVER ASSISTANCE SYSTEM

(71) Applicant: MiTAC Digital Technology Corporation, Taoyuan City (TW)

(72) Inventor: Hsiang-Yu HSIEH, Taoyuan City (TW)

(21) Appl. No.: 19/548,218

(22) Filed: Feb. 24, 2026

(30) Foreign Application Priority Data
Feb. 25, 2025 (TW) 114106874

(51) Int. Cl. G06T 7/80; G06T 7/60; H04N 17/00

(52) U.S. Cl. CPC G06T 7/80; G06T 7/60; H04N 17/002; G06T 2207/20081; G06T 2207/20084; G06T 2207/30244; G06T 2207/30252

(57) ABSTRACT

A method for updating an algorithm of a driver assistance system (DAS) is implemented using an in-vehicle electronic device installed in a vehicle. The algorithm includes a stored height of the camera module. The method includes: obtaining a series of front images from a camera module installed in the vehicle, each of the series of front images including a target object, and processing the series of front images to obtain a plurality of front image datasets each associated with one of the series of front images; estimating, based on information related to a location of the camera module and the plurality of front image datasets, an acquired actual height of the camera module; and updating the algorithm of the DAS by using the acquired actual height of the camera module to replace the stored height of the camera module.

### CROSS-REFERENCE TO RELATED APPLICATION

This application claims priority to Taiwanese Invention Patent Application No. 114106874, filed on Feb. 25, 2025, the entire disclosure of which is incorporated by reference herein.

### FIELD

The disclosure relates to a method for estimating a height of a camera module, more particularly to a method for estimating a height at which a camera module is installed in a vehicle and a method for updating an algorithm of a driver assistance system based on the height of the camera module.

### BACKGROUND

Driver assistance systems (DAS) installed on vehicles may be equipped with image processing technologies, and are capable of providing applications such as lane departure detection, obstacle detection, collision avoidance, etc. For those applications, a camera calibration process may be applied to determine a relationship between a three-dimensional (3D) location of an object in the real world and a two-dimensional (2D) location of an object in an image captured by an in-vehicle camera installed on the vehicle. This may be implemented by performing transformations from a world coordinate system to a camera coordinate system, and then performing transformations from the camera coordinate system to an image coordinate system.

In order to ensure that the DAS functions accurately, it is important to calibrate the inherent parameters of the in-vehicle camera which specifies the camera image format (e.g., focal length, pixel size, and image origin) and to determine an installation height at which the in-vehicle camera is installed on the vehicle. It is noted that after the in-vehicle camera is installed on the vehicle, the installation height of the in-vehicle camera may be measured and stored in the DAS. However the installation height of the in-vehicle camera may change during use of the vehicle, and a driver of the vehicle may not be aware of the change, and even if the change is spotted by the driver, measuring the current installation height of the in-vehicle camera and manually adjusting the in-vehicle camera to fit the installation height originally stored in the DAS may be troublesome for the driver.

### SUMMARY

Therefore, an object of the disclosure is to provide a method for estimating a height at which a camera module is installed in a vehicle.

According to one embodiment of the disclosure, the method is implemented using an in-vehicle electronic device that is installed in a vehicle and that executes a vehicle location and dimension recognition (VLDR) model. The method includes:
A) obtaining a series of front images from a camera module installed in the vehicle, each of the series of front images including a target object;
B) for each of the series of front images, determining coordinate information associated with an original bounding box that encloses the target object, a predicted width of the target object, and a predicted height of the target object, the predicted width and the predicted height of the target object being convertible to a part of a set of world coordinates corresponding to real-world dimensions of the target object;
C) processing the coordinate information and the set of world coordinates associated with each of the series of front images, so as to obtain internal characteristics of the camera module that constitute a camera intrinsic matrix associated with the camera module;
D) calculating, for each of the series of front images, a pitch angle associated with the camera module according to a pinhole camera model, the pitch angles being used to constitute a camera extrinsic matrix associated with the camera module and the corresponding one of the front images;
E) calculating, for each of the series of front images, a plurality of front distances each between the camera module and the target object by iteratively assuming a plurality of preset installation heights, the pitch angle associated with the front image, the internal characteristics of the camera module, and the coordinate information associated with the original bounding box;
F) for each of the front distances calculated for each of the series of front images, implementing a re-projection operation with respect to the target object according to the pinhole camera model, so as to obtain an adjusted bounding box of the target object and an offset value between the original bounding box and the adjusted bounding box as a geometric consistency error;
G) selecting, for each of the series of front images, a candidate installation height for the camera module by selecting one of the plurality of preset installation heights that is associated with a smallest one of offset values calculated in step F) thereby identifying a physically consistent installation height as the candidate installation height; and
H) obtaining an acquired actual installation height of the camera module from among the candidate installation heights and storing the acquired actual installation height as a physical calibration parameter of the camera module for subsequent vehicle perception processing.

According to another embodiment of the disclosure, the method for estimating a height of a camera module installed in the vehicle is implemented using an in-vehicle electronic device that is installed in a vehicle and that executes a vehicle location and dimension recognition (VLDR) model. The method includes the steps of:
A) obtaining a series of front images from a camera module installed in the vehicle, each of the series of front images including a target object;
B) for each of the series of front images, determining coordinate information associated with an original bounding box that encloses the target object, a predicted width of the target object, and a predicted height of the target object;
C) deriving, based on the predicted width and the predicted height of the target object a set of world coordinates with respect to a three-dimensional (3D) world coordinate system associated with a pinhole camera model;
D) processing the coordinate information and the set of world coordinates associated with each of the series of front images, so as to obtain a focal length of the camera module;
E) calculating, for each of the series of front images, a pitch angle associated with the camera module based on the focal length of the camera module, a set of 2D coordinates of a center point of the front image with respect to the image coordinate system and a set of 2D coordinates of a vanishing point of the front image with respect to the image coordinate system;
F) calculating, for each of the series of front images, a plurality of front distances each between the camera module and the target object based on a plurality of preset installation heights, the pitch angle associated with the front image, the focal length of the camera module, the set of 2D coordinates of the vanishing point, and a set of coordinates associated with the target object;
G) implementing, for each of the front distances calculated for each of the series of front images, a re-projection operation with respect to the target object according to the pinhole camera model, so as to obtain an adjusted bounding box of the target object and an offset value between the original bounding box and the adjusted bounding box;
H) selecting, for each of the series of front images, one of the preset installation heights that is associated with a smallest one of offset values as the candidate installation height; and
I) implementing a regression analysis on the candidate installation heights obtained in step H), so as to obtain an acquired actual installation height of the camera module from among the candidate installation heights.

Another object of the disclosure is to provide a method for updating an algorithm of a driver assistance system based on an estimated height of the camera module.

According to one embodiment of the disclosure, the method is implemented using an in-vehicle electronic device installed in a vehicle. The algorithm including a stored installation height of the camera module. The method includes:
A) obtaining a series of front images from a camera module installed in the vehicle, each of the series of front images including a target object;
B) estimating, based on information related to a location relationship between the camera module and the target object in the series of front images, an acquired actual installation height of the camera module; and
C) updating the algorithm of the DAS by using the acquired actual installation height of the camera module to replace the stored installation height.

### BRIEF DESCRIPTION OF THE DRAWINGS

Other features and advantages of the disclosure will become apparent in the following detailed description of the embodiment(s) with reference to the accompanying drawings. It is noted that various features may not be drawn to scale.

FIG. 1 is a flow chart of a method for estimating a height at which a camera module is installed in a vehicle according to one embodiment of the disclosure.

FIG. 2 illustrates an exemplary front image captured by a camera module installed in a vehicle according to one embodiment of the disclosure.

FIG. 3 is a block diagram illustrating an exemplary system for implementing the method for estimating a height at which a camera module is installed in a vehicle according to one embodiment of the disclosure.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

Throughout the disclosure, the term “coupled to” or “connected to” may refer to a direct connection among a plurality of electrical apparatus/devices/equipment via an electrically conductive material (e.g., an electrical wire), or an indirect connection between two electrical apparatus/devices/equipment via another one or more apparatus/devices/equipment, or wireless communication.

It should be noted herein that for clarity of description, spatially relative terms such as “top,” “bottom,” “upper,” “lower,” “on,” “above,” “over,” “downwardly,” “upwardly” and the like may be used throughout the disclosure while making reference to the features as illustrated in the drawings. The features may be oriented differently (e.g., rotated 90 degrees or at other orientations) and the spatially relative terms used herein may be interpreted accordingly.

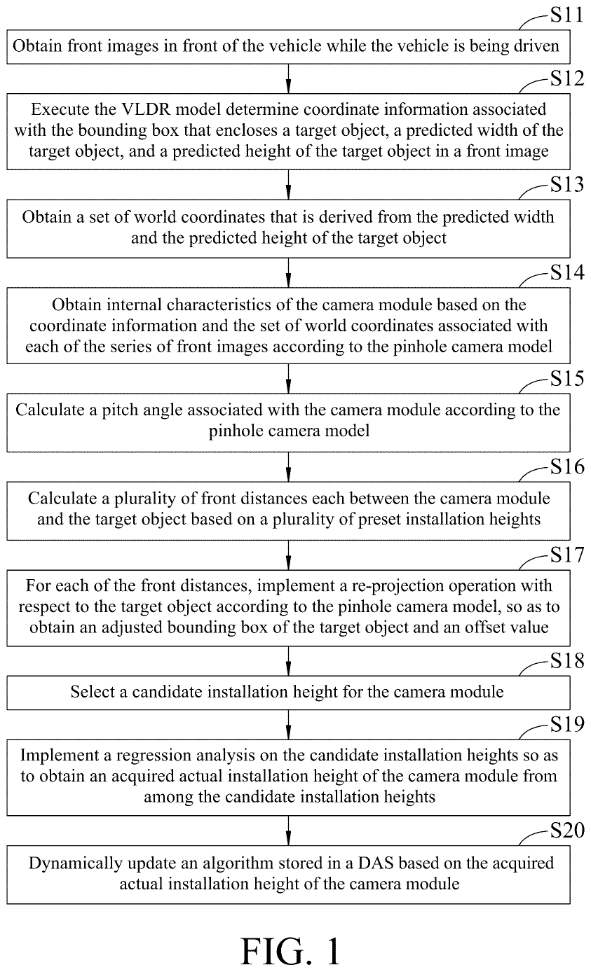

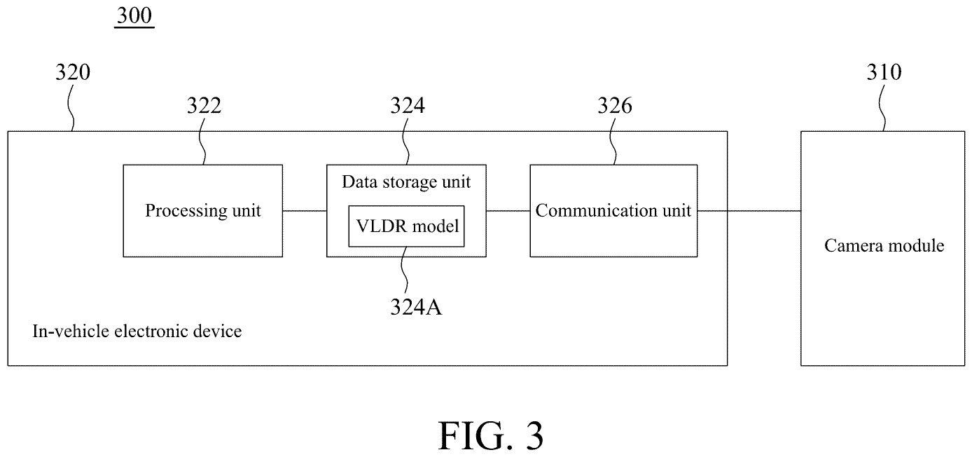

FIG. 1 is a flow chart of a method for estimating a height at which a camera module is installed in a vehicle according to one embodiment of the disclosure. In this embodiment, the method may be implemented using a system. FIG. 3 is a block diagram illustrating an exemplary system 300 according to one embodiment of the disclosure. In the embodiment of FIG. 3, the system 300 is installed on a vehicle (not depicted in the drawings), and includes an in-vehicle electronic device 320 and a camera module 310 connected to the in-vehicle electronic device 320. It should be noted that, throughout the disclosure, the term “height” of an object refers to a distance between the object and the ground, and term “installation height” of the camera module 310 may refer to a lowest point of the camera module 310 and a lowest point of the vehicle.

The camera module 310 may be embodied using a digital video recorder (DVR), and is configured to continuously capture images in front of the vehicle.

The in-vehicle electronic device 320 includes a processing unit 322, a data storage unit 324, and a communication unit 326.

The processing unit 322 may be embodied using a central processing unit (CPU), a microprocessor, a microcontroller, a single core processor, a multi-core processor, a dual-core mobile processor, a digital signal processor (DSP), a field-programmable gate array (FPGA), an application specific integrated circuit (ASIC), and/or a radio-frequency integrated circuit (RFIC), etc.

The data storage unit 324 is electrically connected to the processing unit 322, and may be embodied using, for example, random access memory (RAM), read only memory (ROM), programmable ROM (PROM), firmware, flash memory, etc. In this embodiment, the data storage unit 324 stores a software application and a vehicle location and dimension recognition (VLDR) model 324A therein. The software application includes instructions that, when executed by the processing unit 322, cause the processing unit 322 to implement the operations as described below.

The VLDR model 324A may be embodied using a suitable VLDR model that is pre-trained. The VLDR model 324A may be obtained using a convolutional neural network (CNN) as a backbone, and trained with a plurality of training image datasets using object detection techniques and a modified you only look once (YOLO) loss function. Each of the training image datasets may include an image that is captured by an in-vehicle camera and that contains at least one object (i.e., a front vehicle), and at least one set of actual dimensions (e.g., an actual height and an actual width) of the at least one object. In the case that the at least one object is an automobile, the set of actual dimensions may be obtained by looking up the public information of the automobile from a maker of the automobile.

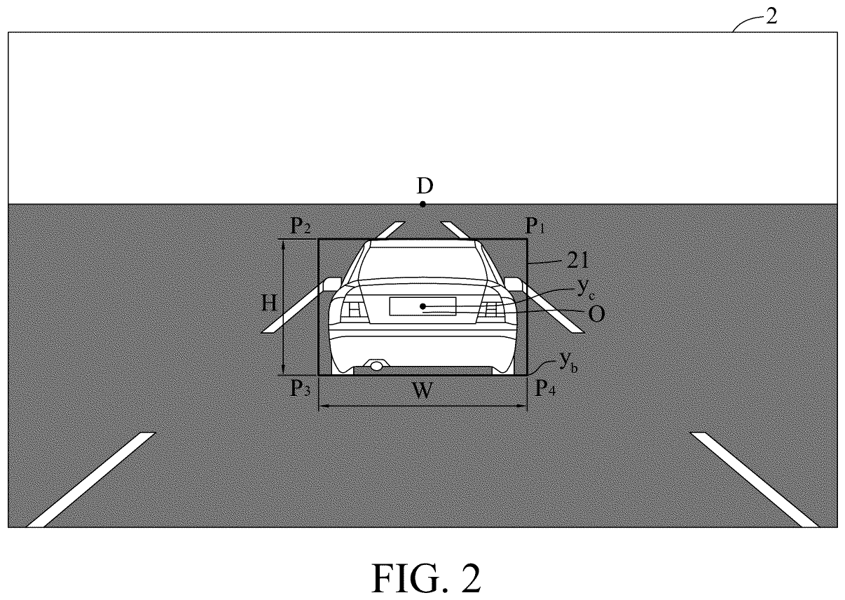

In the embodiment of FIG. 2, the modified YOLO loss function may be obtained by adding a dimension loss function on the publicly available YOLO loss function. The dimension loss function is configured to estimate a difference between an estimated height of an automobile estimated by the VLDR model 324A and the actual height of the automobile, and a difference between an estimated width of the automobile estimated by the VLDR model 324A and the actual width of the automobile.

In use, the VLDR model 324A is configured to process images to detect objects (e.g., a front vehicle) contained in the images. Each of the objects in one image may be enclosed by a rectangular-shaped bounding box that is defined by four sets of two-dimensional (2D) coordinates with respect to a 2D image coordinate system associated with a pinhole camera model.

The communication unit 326 is electrically connected to the processing unit 320 and the camera module 310 through a wired connection (e.g., an electrical wire), and may include one or more of a radio-frequency integrated circuits (RFIC), a short-range wireless communication module supporting a short-range wireless communication network using a wireless technology of Bluetooth® and/or Wi-Fi, etc., and a mobile communication module supporting telecommunication using Long-Term Evolution (LTE), the third generation (3G) of, the fourth generation (4G) of or the fifth generation (5G) of wireless mobile telecommunications technology, or the like. In some embodiments, the communication unit 326 may be communicating with a cloud server via a wireless communication.

The pinhole camera model is a widely used algorithm in the field of computer vision, and is configured to define a three-dimensional (3D) world coordinate system and a 2D coordinate system associated with an image (referred to as an image coordinate system), and to project a set of 3D coordinates in the 3D world coordinate system onto the image coordinate system to obtain a set of 2D coordinates. Typically, the image coordinate system associated with the pinhole camera model defines an upper left point of a rectangular image as an origin, and each pixel of the pixels may be defined as a unit associated with the image coordinate system.

The bounding box of each of the objects may be defined by four points that serve as the four vertices of the bounding box, respectively. The vertices may be represented by Pᵢ(i=1,2,3,4), and each of the vertices may be represented by a set of coordinates (Pᵢx_{image}, Pᵢy_{image}), where Pᵢx_{image} represents a coordinate of an i^{th} vertice of the bounding box with respect to a first axis (e.g., an X axis) of the image coordinate system, and Pᵢy_{image} represents a coordinate of the i^{th} vertice of the bounding box with respect to a second axis (e.g., an Y axis) of the image coordinate system.

The 3D world coordinate system defined by the pinhole camera model may be used to describe an actual location of the camera module 310 and an actual location of an object that is contained in an image captured by the camera module 310. In the embodiment of FIG. 3, in the case where an image captured by the camera module 310 includes one object, an origin of the 3D world coordinate system may be designated as a central point of the target object, an X axis of the 3D world coordinate system may be designated as a horizontal axis, a Y axis of the 3D world coordinate system may be designated as a vertical axis, and a Z axis of the 3D world coordinate system may be designated as an optical axis associated with the camera module 310.

The in-vehicle electronic device 320 may further include hardware components (e.g., processors, data storage components and sensors installed in the vehicle and in communication with the processors) for implementing a driver assistance system (DAS). The DAS is configured to assist the driver to drive the vehicle safely, and may store an algorithm that uses various parameters (e.g., a stored installation height of the camera module 310) for calculating various values (e.g., a front distance between the camera module 310 and an object in front of the vehicle).

In the method shown in FIG. 1, in step S11, while the vehicle is being driven, the camera module 310 is activated to continuously obtain front images in front of the vehicle. For the sake of simplified description, each of the front images contains one target object that is a front vehicle. Generally, the front vehicle is in a same lane with the vehicle and is captured in the front image in its entirety.

Then, in step S12, for each of a series of front images captured by the camera module 310 successively, the processing unit 322 executes the VLDR model 324A to determine coordinate information associated with the bounding box that encloses the target object, a predicted width of the target object, and a predicted height of the target object.

FIG. 2 illustrates an exemplary front image 2 according to one embodiment of the disclosure. The front image 2 includes a target object that is enclosed by a bounding box 21. The bounding box 21 is a rectangle defined by four vertices. The coordinate information associated with the bounding box 21 includes four sets of coordinates Pᵢ(i=1,2,3,4) that indicate the four vertices, respectively. The predicted width of the target object is represented by the label W, and the predicted height of the target object is represented by the label H.

In step S13, for each of the series of front images captured by the camera module 310 successively, the processing unit 322 executes the VLDR model 324A to obtain a set of world coordinates that is derived from the predicted width and the predicted height of the target object. That is to say, The predicted width and the predicted height of the target object may be mapped onto a part of a set of world coordinates corresponding to real-world dimensions of the target object.

Specifically, the set of world coordinates includes four subsets of coordinates, and each of the subsets of coordinates is associated with a respective one of the four vertices. Each subset of coordinates includes at least a first coordinate with respect to a first axis and a second coordinate with respect to a second axis. In the embodiment of FIG. 2, the first axis is the X axis, the second axis is the Y axis, the first coordinate may be represented by PᵢX_{world}(i=1,2,3,4), and the second coordinate may be represented by PᵢY_{world}(i=1,2,3,4).

In the embodiment of FIG. 2, the origin O of the 3D coordinate system is the middle of the bounding box 21, the four vertices of the bounding box 21 are presented using Pᵢ(i=1,2,3,4). As such, the first coordinate of each of the subsets may be represented using

$${P}_{1} {X}_{world} = \frac{W}{2} ,$$

$${P}_{2} {X}_{world} = - \frac{W}{2} ,$$

$${P}_{3} {X}_{world} = - \frac{W}{2}$$

$$and$$

$${P}_{4} {X}_{world} = \frac{W}{2} ,$$

respectively, and the second coordinate of each of the subsets may be represented using

$${P}_{1} {Y}_{world} = \frac{H}{2} ,$$

$${P}_{2} {Y}_{world} = \frac{H}{2} ,$$

$${P}_{3} {Y}_{world} = - \frac{H}{2}$$

$$and$$

$${P}_{4} {Y}_{world} = - \frac{H}{2} ,$$

respectively.

Then, in step S14, the processing unit 322 obtains internal characteristics of the camera module 310 based on the coordinate information and the set of world coordinates associated with each of the series of front images according to the pinhole camera model. Specifically, the internal characteristics of the camera module 310 include a focal length (Fx, Fy) and a principal point (Cx, Cy) of the camera module 310, and are used to constitute a camera intrinsic matrix associated with the camera module 310. In use, the pinhole camera model may be embodied using the open source computer vision library (OPENCV), and since the pinhole camera model is readily known in the related field, details thereof are omitted herein for the sake of brevity.

In step S15, for each of the series of front images, the processing unit 322 calculates a pitch angle associated with the camera module 310 according to the pinhole camera model.

Specifically, the processing unit 322 calculates the pitch angle based on the focal length of the camera module 310, a set of 2D coordinates of a center point of the front image with respect to the image coordinate system and a set of 2D coordinates of a vanishing point of the front image with respect to the image coordinate system to calculate the pitch angle. The vanishing point may be defined as a point where the lane on which the vehicle is driving ends (labeled as D in the example of FIG. 2).

That is to say, using a Y coordinate of the set of 2D coordinates of the center point with respect to the Y axis of the image coordinate system, a Y coordinate of the set of 2D coordinates of the vanishing point with respect to the Y axis of the image coordinate system, and the focal length of the camera module 310, the pitch angle may be calculated using the following formula:

$$θ = {tan}^{- 1} ( \frac{{y}_{c} - {y}_{h}}{{F}_{c}} )$$

where θ represents the pitch angle, y_{c} represents the Y coordinate of the set of 2D coordinates of the center point, yₕ represents the Y coordinate of the set of 2D coordinates of the vanishing point, and F_{c} represents the focal length of the camera module 310. The pitch angle is used to constitute a camera extrinsic matrix associated with the camera module 310 and the corresponding one of the front images.

It is noted that a distance between the vehicle and the front vehicle (i.e., the target object) calculated based on the images captured by the camera module 310 (a triangular geometric depth derived from the optical axis of the camera module 310) and an actual distance between the vehicle and the front vehicle may be different based on the installation height of the camera module 310. It is noted that calculating the camera extrinsic matrix using the camera intrinsic matrix is readily known in the related art, details thereof are omitted herein for the sake of brevity.

As such, with the pitch angle for each of the series of front images calculated, in step S16, the processing unit 322 calculates, for each of the series of front images, a plurality of front distances each between the camera module 310 and the target object based on a plurality of preset installation heights, the pitch angle associated with the front image, the focal length of the camera module 310, the Y coordinate of the set of 2D coordinates of the vanishing point, and a Y coordinate associated with a bottom horizontal edge of the bounding box 21. It should be noted that the front distances are calculated by iteratively assuming the preset installation heights, respectively.

In the embodiment of FIG. 1, each of the front distances may be calculated using the following formula:

$${Z}_{world} = \frac{1}{{cos}^{2} ( θ )} \times \frac{{F}_{c} \times camH}{dy ( {y}_{b} - {y}_{h} )} - camH \times tan ( θ )$$

where Z_{world} represents the front distance indicated by a Z coordinate of the target object in the 3D world coordinate system, camH represents the corresponding one of the preset installation heights, and dy represents an actual height of a pixel appearing on an image sensor of the camera module 300.

It is noted that, the preset installation heights may be predetermined according to the height of various types of vehicles, and in a range of 100 centimeters, which is approximately a minimum height of a sedan, to 300 centimeters, which is approximately a maximum height of a large truck. In some embodiments, the preset installation height may be chosen as integer numbers within the range (e.g., 100 cm, 101 cm, 102 cm, . . . , and 300 cm). Accordingly, in the embodiment of FIG. 1, each of the integers between 100 to 300 is assumed as a preset installation height. 201 front distances may be calculated for each of the series of front images. The preset installation heights (e.g., 100 centimeters to 300 centimeters) is preset according to the type of vehicle being tested, and sampling is performed with a fixed step value (e.g., 1 cm). Additionally, it should be noted that, If the step value is too large (e.g., 10 cm), accuracy will be lost; if it is too small (e.g., 0.1 cm), computational resources will be wasted. This aims to achieve a balance between computational efficiency and estimation accuracy.

Then, in step S17, for each of the front distances calculated for each of the series of front images, the processing unit 322 implements a re-projection operation with respect to the target object according to the pinhole camera model, so as to obtain an adjusted bounding box of the target object and an offset value between the bounding box that is determined in step S12 (hereinafter referred to as “original bounding box”) and the adjusted bounding box as a geometric consistency error.

The adjusted bounding box of the target object may be defined by four points that serve as the four vertices of the adjusted bounding box, respectively. The vertices may be represented by

$${P}_{i}^{′} ( i - 1 , 2 , 3 , 4 ) .$$

and each of the vertices may be represented by a set of coordinates

$$( {P}_{i}^{′} {x}_{image} , {P}_{i}^{′} {y}_{image} ) ,$$

$$where$$

$${P}_{i}^{′} {x}_{image}$$

represents a coordinate of an i^{th} vertice of the adjusted bounding box with respect to the first axis of the image coordinate system, and

$${P}_{i}^{′} {y}_{image}$$

represents a coordinate of the i^{th} vertice of the adjusted bounding box with respect to the second axis of the image coordinate system.

In the embodiment of FIG. 1, the set of coordinates

$$( {P}_{i}^{′} {x}_{image} , {P}_{i}^{′} {y}_{image} )$$

representing each of the vertices of the adjusted bounding box may be calculated using the following formula:

$$A \cdot B \cdot [ \begin{matrix}{P}_{i} {X}_{world} \\ {P}_{i} {Y}_{world} \\ {Z}_{world}\end{matrix} ] = [ \begin{matrix}{P}_{i}^{′} {x}_{image} \\ {P}_{i}^{′} {y}_{image} \\ 1\end{matrix} ] \cdot S$$

where A represents the camera intrinsic matrix, B represents the camera extrinsic matrix associated with the front image, and S represents a scale factor which may set as 1, or may be other constants that may be adjusted based on different usages of the method.

The offset value between the original bounding box and the adjusted bounding box may be calculated by first calculating, for each of the vertices of the original bounding box, a Euclidean distance between the set of coordinates of the vertex of the original bounding box and the set of coordinates of a corresponding one of the vertices of the adjusted bounding box, resulting in four Euclidean distances, and then adding up the four Euclidean distances to obtain a sum serving as the offset value. As such, for the embodiment of FIG. 1, a total of 201 offset values each associated with one of the preset installation heights are calculated. It is noted that in some embodiments, in order to obtain a more accurate result, it may be desirable to process at least a predetermined number of front images. In some embodiments, at least 30 front images obtained in a predetermined time frame (e.g., about 5 to 10 seconds), which indicates that the vehicle has been moving for some time, are processed in a similar manner as described above, but other preset heights and other number of front images may be chosen in different embodiments.

In step S18, the processing unit 322 selects, for each of the series of front images, a candidate installation height for the camera module 310. Specifically, in the embodiment of FIG. 1, the processing unit 322 selects one of the preset installation heights that is associated with a smallest one of offset values calculated in step S17, thereby identifying a physically consistent installation height as the candidate installation height for the camera module 310, which is considered a relatively more likely installation height of the camera module 310. As such, a plurality of candidate installation heights are selected respectively for the series of front images. For example, in the embodiments where 30 front images are processed, 30 candidate installation heights are selected.

In step S19, the processing unit 322 implements a regression analysis on the candidate installation heights obtained in step S19, and implements a maximum likelihood function so as to obtain an acquired actual installation height of the camera module 310 from among the candidate installation heights, which is considered a most likely installation height of the camera module 310 that maximizes the maximum likelihood function.

Specifically, in the embodiment of FIG. 1, the processing unit 322 calculates the most likely installation height as shown below:

$$ln ( L ( ⌀ ) ) = n \cdot ln \frac{1}{\sqrt{2 {πσ}^{2}}} - \frac{1}{2 {σ}^{2}} {\sum }_{i = 1}^{n} {( {ε}_{i} )}^{2}$$

where L represents the maximum likelihood function associated with a normal distribution, Ø represents a parameter associated with the maximum likelihood function, σ represents a standard deviation associated with the normal distribution, and εᵢ represents an offset value associated with an i^{th} one of the candidate installation heights. In addition, the calculated results may be further observed by using a regression curve. the regression curve may be a 2D curve that includes a plurality of points each representing one of the candidate installation heights, and each having a Y coordinate that indicates a likelihood of being the acquired actual installation height of the camera module 310. Then, the processing unit 322 selects one of the candidate installation heights that has a lowest Y coordinate on the regression curve as the acquired actual installation height of the camera module 310.

It is noted that in other embodiments, the regression curve may be plotted using other suitable regression analysis processes, such as the least squares method.

In the embodiment of FIG. 1, the operations of step S19 are implemented since the previous calculations are done based on the predicted width of the target object and the predicted height of the target object that are estimated by the VLDR model 324A, and in order to minimize the potential estimation error on the predicted width of the target object and the predicted height of the target object by the VLDR model 324A, each of the series of the front images are processed, and each of the plurality of candidate installation heights of the camera module 310 are considered before selecting one of the candidate installation heights of the camera module 310 as the acquired actual installation height of the camera module 310. Then, the processing unit 322 stores the acquired actual installation height as a physical calibration parameter of the camera module for subsequent vehicle perception processing.

Alternatively, in some embodiments, the processing unit 322 may directly select the candidate installation height of a single one of the series of front images as the acquired actual installation height of the camera module 310, and the operations of step S19 may be omitted. In some embodiments, the method may be implemented with respect to one front image. It is noted that such a configuration is more beneficial in cases where the computation capabilities of the processing unit 322 is limited.

Then, in step S20, the processing unit 322 dynamically updates the algorithm stored in the DAS based on the acquired actual installation height of the camera module 310. Specifically, in the case that the acquired actual installation height of the camera module 310 differs from the stored installation height of the camera module 310 stored in the DAS, the processing unit 322 replaces the stored installation height of the camera module 310 with the acquired actual installation height of the camera module 310. As such, in the case that the installation height of the camera module 310 changes from the stored installation height, the processing unit 322 implementing the method of FIG. 1 is capable of detecting the change and dynamically updating the algorithm stored in the DAS. Then, the method may be repeated for another series of front images captured by the camera module 310 subsequently.

In some embodiments, in addition to updating the algorithm, the processing unit 322 may further generate and output an alert to notify the user that the installation height of the camera module 310 has been changed from the stored installation height, such that the user may be instructed to manually adjust the installation height of the camera module 310 to the stored installation height or consult an automobile repair shop to adjust the installation height of the camera module 310 to the stored installation height.

It is noted that, in the case where the acquired actual installation height of the camera module 310 is identical to the stored installation height, it may be deduced that the camera module 310 is properly placed, and the algorithm does not need to be updated. As such, the method may be repeated for another series of front images captured by the camera module 310 subsequently.

In some embodiments, the in-vehicle electronic device may be configured to implement the method by taking one or more of the following factors into consideration: 1) the real-world dimensions of the target object (i.e., the front vehicle); 2) information extracted from a series of front images acquired during a time frame; and 3) one or more of preset installation heights in a predetermined range. In this manner, using multi-frame statistical and range-limited design, combined with Maximum Likelihood Function and regression analysis, can calculate a long-term stable true installation height of the camera module 310, effectively offsetting the prediction error of the VLDR model in a single image.

Furthermore, in dynamic environments of actual road driving (such as when encountering road bumps or impacts causing device displacement, or when changes in lighting cause sampling errors), it provides estimation results with high robustness and temporal stability, thereby ensuring the accuracy of subsequent driver assistance system calculations, providing more valuable calculation results.

By using a series of front images that are taken during a time frame while the vehicle is being driven, front distances calculated for each of the series of front images may differ from one another. In this manner, more diversified data may be obtained for the subsequent calculation, which may provide a more accurate calculation result that can assist with dynamic calculation of the acquired actual installation height, and the associated actions may be implemented to adjust the camera module 310.

According to one embodiment of the disclosure, there is provided a method for updating an algorithm of a driver assistance system (DAS) based on a height of a camera module installed on the vehicle. The method is implemented using an in-vehicle electronic device installed in a vehicle. The algorithm includes a stored installation height of the camera module. The method includes the following steps of:
obtaining a series of front images from the camera module installed in the vehicle, each of the series of front images including a target object;
estimating, based on information related to a location relationship between the camera module and the target object in the series of front images, an acquired actual installation height of the camera module; and
updating the algorithm of the DAS by using the acquired actual installation height of the camera module to replace the stored installation height.

In some embodiments, the step of estimating the acquired actual installation height of the camera includes estimating a plurality of candidate installation heights, and implementing a regression analysis to select one of the plurality of candidate installation heights as the acquired actual installation height of the camera module.

To sum up, embodiments of the disclosure provides a method for estimating a height at which a camera module is installed. In the method, the processing unit is configured to continuously calculate an acquired actual installation height of the camera module 310 based on a series of images captured by the camera module 310. As such, any change in the installation height of the camera module 310 may be easily monitored by the driver.

Additionally, based on the installation height of the camera module 310 estimated, a method for updating an algorithm of a driver assistance system (DAS) may be implemented. By dynamically updating the stored installation height of the camera module 310, the calculations done by the algorithm may be ensured to be more accurate, and the potential issue of false alarms resulting from incorrect calculations attributed to the installation height of the camera module 310 being changed from the stored installation height, and the proceeding unit 322 erroneously uploading the false alarm to the cloud server may be alleviated.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what is(are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A method for estimating a height at which a camera module is installed in a vehicle, the method being implemented using an in-vehicle electronic device that is installed in a vehicle and that executes a vehicle location and dimension recognition (VLDR) model, the method comprising:
A) obtaining a series of front images from a camera module installed in the vehicle, each of the series of front images including a target object;
B) for each of the series of front images, determining coordinate information associated with an original bounding box that encloses the target object, a predicted width of the target object, and a predicted height of the target object, the predicted width and the predicted height of the target object being able to be mapped to a part of a set of world coordinates corresponding to real-world dimensions of the target object;
C) processing the coordinate information and the set of world coordinates associated with each of the series of front images, so as to obtain internal characteristics of the camera module that constitute a camera intrinsic matrix associated with the camera module;
D) calculating, for each of the series of front images, a pitch angle associated with the camera module according to a pinhole camera model, the pitch angles being used to constitute a camera extrinsic matrix associated with the camera module and the corresponding one of the front images;
E) calculating, for each of the series of front images, a plurality of front distances each between the camera module and the target object by iteratively assuming a plurality of preset installation heights, the pitch angle associated with the front image, the internal characteristics of the camera module, and the coordinate information associated with the original bounding box;
F) for each of the front distances calculated for each of the series of front images, implementing a re-projection operation with respect to the target object according to the pinhole camera model, so as to obtain an adjusted bounding box of the target object and an offset value between the original bounding box and the adjusted bounding box as a geometric consistency error;
G) selecting, for each of the series of front images, a candidate installation height for the camera module by selecting one of the plurality of preset installation heights that is associated with a smallest one of offset values calculated in step F) thereby identifying a physically consistent installation height as the candidate installation height; and
H) obtaining an acquired actual installation height of the camera module from among the candidate installation heights and storing the acquired actual installation height as a physical calibration parameter of the camera module for subsequent vehicle perception processing.

2. The method as claimed in claim 1, wherein the VLDR model is trained with a plurality of training image datasets using object detection techniques and a dimension loss function that is configured to estimate a difference between an estimated height and an estimated width of an automobile estimated by the VLDR model and the actual height and the actual width of the automobile, respectively.

3. The method as claimed in claim 1, wherein a number of the series of front images is larger than a predetermined number, and the series of front images is obtained in a predetermined time frame while the vehicle is moving.

4. The method as claimed in claim 3, wherein the predetermined number is 30, and the predetermined time frame is between 5 to 10 seconds.

5. A method for estimating a height of a camera module installed in the vehicle, the method being implemented using an in-vehicle electronic device that is installed in a vehicle and that executes a vehicle location and dimension recognition (VLDR) model, the method comprising:
A) obtaining a series of front images from a camera module installed in the vehicle, each of the series of front images including a target object;
B) for each of the series of front images, determining coordinate information associated with an original bounding box that encloses the target object, a predicted width of the target object, and a predicted height of the target object;
C) deriving, based on the predicted width and the predicted height of the target object a set of world coordinates with respect to a three-dimensional (3D) world coordinate system associated with a pinhole camera model;
D) processing the coordinate information and the set of world coordinates associated with each of the series of front images, so as to obtain a focal length of the camera module;
E) calculating, for each of the series of front images, a pitch angle associated with the camera module based on the focal length of the camera module, a set of 2D coordinates of a center point of the front image with respect to the image coordinate system and a set of 2D coordinates of an vanishing point of the front image with respect to the image coordinate system;
F) calculating, for each of the series of front images, a plurality of front distances each between the camera module and the target object based on a plurality of preset installation heights, the pitch angle associated with the front image, the focal length of the camera module, the set of 2D coordinates of the vanishing point, and a set of coordinates associated with the target object;
G) implementing, for each of the front distances calculated for each of the series of front images, a re-projection operation with respect to the target object according to the pinhole camera model, so as to obtain an adjusted bounding box of the target object and an offset value between the original bounding box and the adjusted bounding box;
H) selecting, for each of the series of front images, one of the preset installation heights that is associated with a smallest one of offset values as the candidate installation height; and
I) implementing a maximum likelihood function on the candidate installation heights obtained in step H), so as to obtain an acquired actual installation height of the camera module from among the candidate installation heights.

6. The method as claimed in claim 5, wherein the VLDR model is trained with a plurality of training image datasets using object detection techniques and a dimension loss function that is configured to estimate a difference between an estimated height and an estimated width of an automobile estimated by the VLDR model and the actual height and the actual width of the automobile, respectively.

7. The method as claimed in claim 5, wherein step E) includes calculating the pitch angle using the following formula:
$$θ = {tan}^{- 1} ( \frac{{y}_{c} - {y}_{h}}{{F}_{c}} )$$
where θ represents the pitch angle, y_{c} represents the Y coordinate of the set of 2D coordinates of the center point, y_{A} represents the Y coordinate of the set of 2D coordinates of the vanishing point, and F_{c} represents the focal length of the camera module.

8. The method as claimed in claim 5, wherein step F) includes calculating each of the plurality of front distances using the following formula:
$${Z}_{world} = \frac{1}{{cos}^{2} ( θ )} \times \frac{{F}_{c} \times camH}{dy ( {y}_{b} - {y}_{h} )} - camH \times tan ( θ )$$
where Z_{world} represents the front distance indicated by a Z coordinate of the target object in the 3D world coordinate system, camH represents the corresponding one of the preset installation heights, and dy represents an actual height of a pixel appearing on an image sensor of the camera module.

9. The method as claimed in claim 5, wherein:
each of the original bounding box and the adjusted bounding box is a rectangle with four vertices;
step G) includes obtaining the adjusted bounding box by calculating a set of coordinates
$$( {P}_{i}^{′} {x}_{image} , {P}_{i}^{′} {y}_{image} )$$
representing each of the four vertices of the adjusted bounding box using the following formula:
$$A \cdot B \cdot [ \begin{matrix}{P}_{i} {X}_{world} \\ {P}_{i} {Y}_{world} \\ {Z}_{world}\end{matrix} ] = [ \begin{matrix}{P}_{i}^{′} {x}_{image} \\ {P}_{i}^{′} {y}_{image} \\ 1\end{matrix} ] \cdot S$$
where A represents the camera intrinsic matrix, B represents an extrinsic matrix associated with the front image that may be calculated using camera calibration techniques, and S represents a scale factor.

10. The method as claimed in claim 5, wherein a number of the series of front images is larger than a predetermined number, and the series of front images is obtained in a predetermined time frame while the vehicle is moving.

11. The method as claimed in claim 10, wherein the predetermined number is 30, and the predetermined time frame is between 5 to 10 seconds.

12. A method for updating an algorithm of a driver assistance system (DAS), the method being implemented using an in-vehicle electronic device installed in a vehicle, the algorithm including a stored installation height of the camera module, the method comprising:
A) obtaining a series of front images from a camera module installed in the vehicle, each of the series of front images including a target object;
B) estimating, based on information related to a location relationship between the camera module and the target object in the series of front images, an acquired actual installation height of the camera module; and
C) updating the algorithm of the DAS by using the acquired actual installation height of the camera module to replace the stored installation height.

13. The method as claimed in claim 12, wherein step B) includes:
estimating a plurality of candidate installation heights; and
implementing a implements a maximum likelihood function to select one of the plurality of candidate installation heights as the acquired actual installation height of the camera module that maximizes the maximum likelihood function.
